(19) United States
(12) Patent Application Publication
(10) Pub. No.: US 2023/0263146 A1
(43) Pub. Date: Aug. 24, 2023

(54) REEL SEAT

(71) Applicant: GLOBERIDE, Inc., Tokyo (JP)

(72) Inventors: Kyoichi KANEKO, Tokyo (JP); Yoshinao KATO, Tokyo (JP); Masaru AKIBA, Tokyo (JP)

(21) Appl. No.: 18/023,990

(22) PCT Filed: Aug. 6, 2021
(86) PCT No.: PCT/JP2021/029411

§ 371 Date: Feb. 28, 2023

(30) Foreign Application Priority Data
Aug. 28, 2020 (JP) 2020-144053

(51) Int. Cl. A01K 87/06

(52) U.S. Cl. CPC A01K 87/06

(57) ABSTRACT

In a reel seat of the present disclosure, a position of a reel leg placement portion on which a reel leg of a fishing reel is placed is offset in a descending direction with respect to a position of an axial center of a rod. An inclined surface connecting an upper end position of a hood portion defining an opening of a fixed hood to a grip upper surface gripped on the rear side of the fishing reel is provided on the rear side of the fishing reel attached to and fixed to the reel leg placement portion, and the inclined surface is formed such that an inclination angle α of rising toward the grip upper surface from the upper end position of the hood portion does not exceed 45° and an inclination angle β of descending from the grip upper surface does not exceed 35° in side view.

### CROSS-REFERENCE TO RELATED APPLICATIONS

The present application is a National Stage of International Application No. PCT/JP2021/029411 filed on Aug. 6, 2021 which claims priority to and the benefit of Japanese Patent Application No. 2020-144053 filed on Aug. 28, 2020, the contents of which are incorporated herein by reference in their entirety.

### FIELD

The present disclosure relates to a reel seat attached to various fishing rods such as a lure rod and a ship rod and used for mounting and fixing a reel.

### BACKGROUND

Conventionally, in a fishing rod using a reel, a reel seat for mounting the reel is fixed to a root rod, and as such a reel seat, a tubular reel seat fixed to an outer peripheral surface of the root rod has been known. In general, since the root rod penetrates the tubular reel seat, a strength of the reel seat can be secured by the root rod, and a weight thereof can be reduced by using a lightweight material, reducing a thickness, or the like.

When a double-bearing reel having a circular shape in which side plates are formed in a circular shape is mounted on the reel seat described above, the position of thumbing the fishing line wound around the spool is shifted upward at the time of actual fishing, and the palm is easily opened at the time of casting, so that the operability is degraded. In addition, if the clutch lever that switches the spool to a free rotation state is disposed so as to protrude from the upper surface of a side plate, the palm is more likely to open when operating the clutch.

In particular, since recent base rods tend to have a large diameter and length, when a tubular reel seat is fixed to such a large-diameter base rod, the palm tends to be easily opened at the time of operation in the actual fishing, and the operability is degraded. In addition, when the center of gravity is located above the grip and forces in left and right directions are applied to the reel, a strong rotational force (torque) is applied to the grip, and the grip needs to be gripped with a strong force (the torque decreases as the center of gravity of the reel becomes lower).

Therefore, as disclosed in Patent Literatures 1 to 3, a reel seat (also referred to as an offset reel seat) in which the position of the reel leg placement portion of the reel seat is offset in the direction of descending with respect to the axial center of the base rod is known. According to such an offset reel seat, since the reel leg placement portion is shifted downward, even if a grip portion on the rear side is gripped when the round double-bearing reel is attached, the operation position of the thumb does not become high, and it is possible to suppress decrease in the operability due to opening of the palm.

### CITATION LIST

### Patent Literature

Patent Literature 1: Japanese Utility Model Application Laid-Open No. S49-122082

Patent Literature 2: Japanese Examined Utility Model Application Publication No. S49-46557

Patent Literature 3: Japanese Examined Utility Model Application Publication No. S50-24539

### SUMMARY

According to the offset reel seat as described above, it is possible to easily perform the clutch operation even in the case of a double-bearing reel in which the clutch lever that brings the spool into the free rotation state during the casting operation is disposed so as to protrude from the surface of the side plate. However, in many recent double-bearing reels, the clutch lever is disposed between the left and right side plates on the rear side of the spool to be pushed down/pushed up in the up-down direction. In conventional offset reel seats, the rear side (rear wall portion) of the mounted reel is not sufficiently considered, and in a double-bearing reel having the clutch lever disposed between the left and right side plates as described above, there is a problem that the clutch switching operability at the time of actual fishing is poor, and a series of operations cannot be smoothly performed.

That is, if the inclination angle of the rear wall portion rising from a hood portion (fixed hood) into which the reel leg is inserted is steep or the gap between the rear wall portion and the reel body is narrow, a problem arises that the clutch lever cannot be smoothly pushed down, and further, when the clutch lever is pushed up to turn on the clutch, the thumb is hard to be inserted into the lower surface side of the clutch operation lever, and the like. In particular, when a low profile one such as a small bait reel is mounted as a double-bearing reel for casting, a problem arises that the position of the clutch operation lever also becomes lower, the gap becomes narrower, and the clutch cannot be disengaged, the push-up operation of the clutch lever cannot be performed, or the like.

The present disclosure has been made in view of the above problems, and an object of the present disclosure is to provide a reel seat that enables smoothly performing a series of operations when gripping and holding a fishing rod with a fishing reel.

To achieve the object described above, the reel seat according to the present disclosure has a configuration comprising a seat body including a reel leg placement portion on which a reel leg of a fishing reel is placed, a fixed hood provided on a rear side of the reel leg placement portion in an axial direction, and a moving hood provided on a front side of the reel leg placement portion in the axial direction and in which a position of the reel leg placement portion is offset in a descending direction with respect to a position of an axial center of a rod when the seat body is fixed to the rod, and comprises an inclined surface provided on a rear side of the fishing reel attached to and fixed to the reel leg placement portion and connecting an upper end position of a hood portion defining an opening of the fixed hood to a grip upper surface gripped on the rear side of the fishing reel, and the inclined surface is formed such that an inclination angle of rising toward the grip upper surface from the upper end position of the hood portion does not exceed 45° and an inclination angle of descending from the grip upper surface does not exceed 35° in side view.

In the seat body of the reel seat described above, since the reel leg placement portion is offset in the direction of descending with respect to the axial center of the rod to be fixed, the operation of the clutch lever and the like can be performed without largely opening the palm when the grip portion on the rear side of the fishing reel that is attached and fixed is gripped. In this case, in the inclined surface provided on the rear side of the fishing reel attached to and fixed to the reel leg placement portion, the inclination angle of rising from the upper end position of the hood portion toward the grip upper surface does not exceed 45° in side view, therefore the inclination angle becomes gentle, a gap on the rear side of the clutch lever can be secured, and the clutch lever can be easily operated. In particular, since the inclination angle of descending from the grip upper surface is formed to not exceed 35° , the inclination on the upper end side becomes gentle, and the clutch lever can be operated satisfactorily even if a low-profile double-bearing reel whose operation position of the clutch lever is low is attached.

To achieve the object described above, the reel seat according to the present disclosure has a configuration comprising a seat body including a reel leg placement portion on which a reel leg of a fishing reel is placed, a fixed hood provided on a rear side of the reel leg placement portion in an axial direction, and a moving hood provided on a front side of the reel leg placement portion in the axial direction and in which a position of the reel leg placement portion being offset in a descending direction with respect to a position of an axial center of a rod when the seat body is fixed to the rod, and comprises an inclined surface provided on a rear side of the fishing reel attached to and fixed to the reel leg placement portion and connecting an upper end position of a hood portion defining an opening of the fixed hood to a grip upper surface gripped on the rear side of the fishing reel, and a cross-sectional shape of a surface of the inclined surface in a direction orthogonal to the axial direction has a recessed portion whose central region is depressed.

Since a cross-sectional shape of a surface of the inclined surface of the seat body of the reel seat described above in a direction orthogonal to the axial direction has a recessed portion whose central region is depressed the ball of the thumb can be stably brought into contact therewith, and then stretched forward to easily perform push-down operation and push-up operation of the clutch lever.

According to the reel seat of the present disclosure, a series of operations can be smoothly performed when a fishing rod is gripped and held together with a fishing reel.

### BRIEF DESCRIPTION OF THE DRAWINGS

FIG. 1 is a diagram illustrating a state in which a fishing reel of a low profile type is attached to and fixed to a reel seat according to the present disclosure, and is an axial section view of a reel seat portion.

FIG. 2 is an exploded perspective view of the reel seat illustrated in FIG. 1.

FIG. 3 is a diagram illustrating the reel seat illustrated in FIG. 1, in which FIG. 3(a) is a plan view, FIG. 3(b) is a side view, and FIG. 3(c) is a back view.

FIG. 4(a) is an axial section view of a seat body portion of the reel seat illustrated in FIG. 1, and FIG. 4(b) is a section view of an inclined surface viewed from a direction orthogonal to the axial direction.

FIG. 5 is a diagram illustrating a use state of the reel seat, in which FIG. 5(a) is a diagram illustrating a clutch-ON state of a mounted fishing reel, FIG. 5(b) is a diagram illustrating a state of a thumb for switching to clutch-OFF, and FIG. 5(c) is a diagram illustrating a state of the thumb for switching to clutch-ON.

FIG. 6 is a diagram illustrating a modification example of the reel seat, in which FIG. 6(a) is an axial section view illustrating a state in which a round fishing reel is attached to and fixed to the reel seat, and FIG. 6(b) is a section view of an inclined surface viewed from a direction orthogonal to the axial direction.

FIG. 7 is a diagram illustrating a second modification example of the reel seat, in which FIG. 7(a) is an axial section view, FIG. 7(b) is a plan view, and FIG. 7(c) is an A direction section view of FIG. 7(a).

### DETAILED DESCRIPTION

Hereinafter, an embodiment of a reel seat according to the present disclosure will be specifically described with reference to the accompanying drawings.

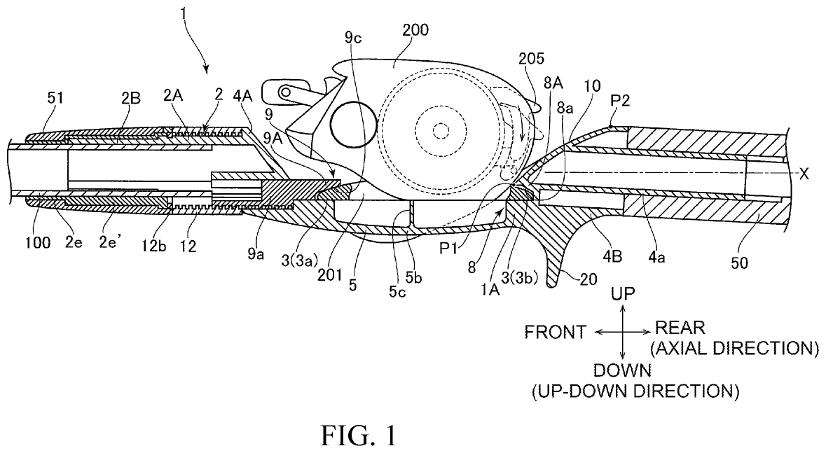

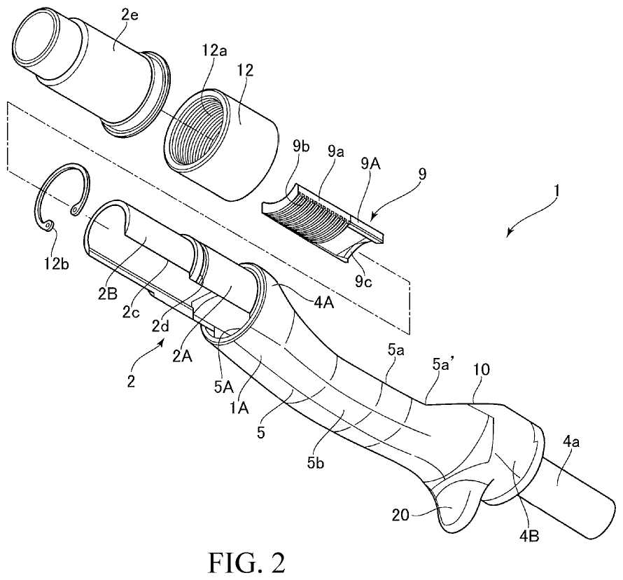

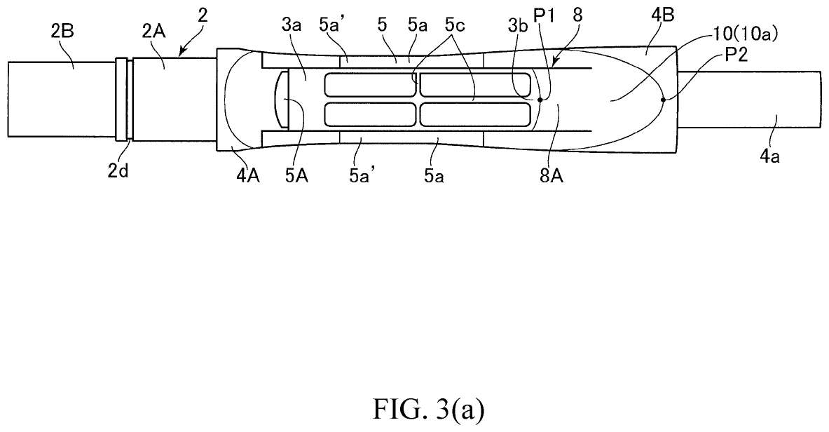

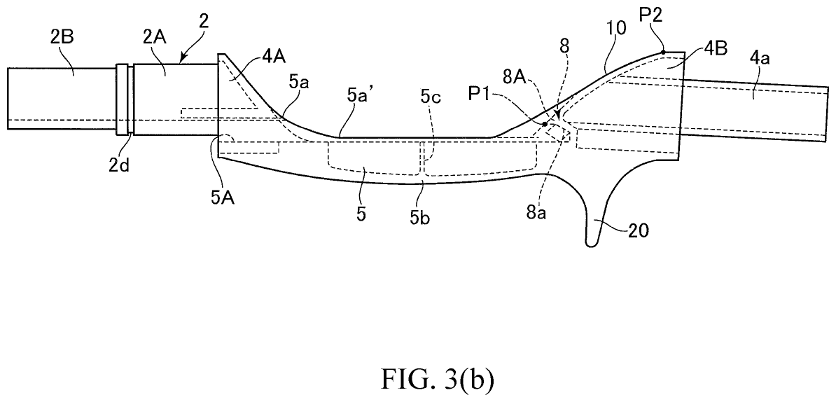

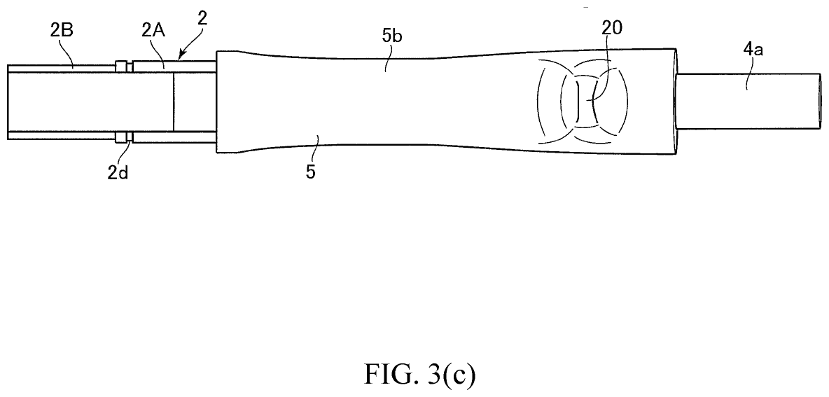

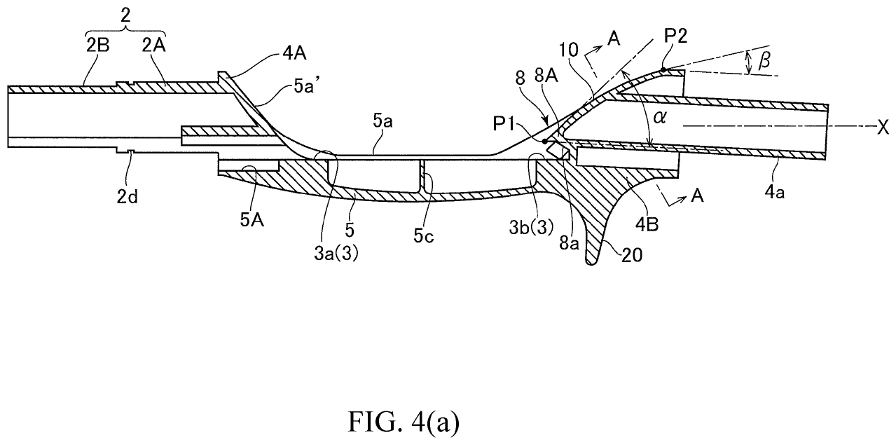

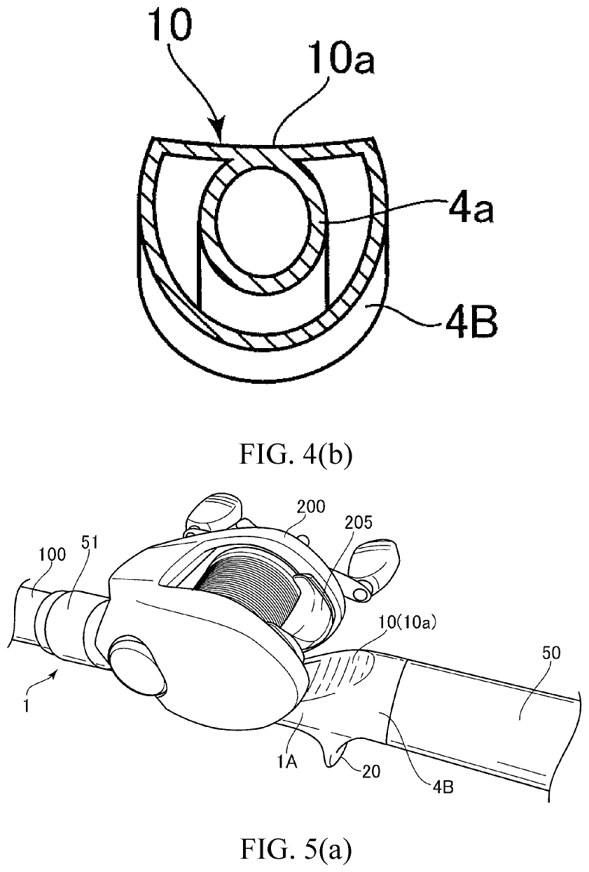

FIGS. 1 to 4 are diagrams illustrating an embodiment of a reel seat according to the present disclosure, in which FIG. 1 is a diagram illustrating a state in which a fishing reel of a low profile type is mounted and fixed, FIG. 2 is an exploded perspective view of the reel seat illustrated in FIG. 1, FIG. 3(a) is a plan view, FIG. 3(b) is a side view, FIG. 3(c) is a back view, FIG. 4(a) is an axial section view of a seat body portion, and FIG. 4(b) is a section view of an inclined surface viewed from a direction orthogonal to the axial direction.

In the following description, the axial direction (front-rear direction) and an up-down direction mean directions illustrated in FIG. 1, and a right-left direction (side direction) means a direction orthogonal to a paper surface of FIG. 1. That is, a front side means a distal end side of a fishing rod, a rear side means a proximal end side, an upper side means a reel side with respect to an axial center X of the base rod (rod) when the double-bearing reel is mounted, and a lower side means an opposite side of the reel side. In addition, as described above, the present disclosure is directed to a reel seat (offset reel seat) in which the position of the reel leg placement portion is offset in the direction of descending with respect to the axial center X of the fixed base rod. The descending direction means the downward direction illustrated in FIG. 1. Therefore, when the double-bearing reel is attached to the reel leg placement portion of such a reel seat, the position of the reel leg is shifted downward with respect to the axial center X of the fixed base rod, and when the grip portion on the rear side of the reel is gripped, the thumb can be brought into contact with the reel body without largely opening the palm.

A seat body 1A of a reel seat 1 according to the present disclosure comprises a front cylindrical portion 4A in which a cylindrical portion 2 having a substantially cylindrical shape is formed in a protruding manner on the front side, and a grip portion (rear grip) 50 gripped and held is fixed to the rear side. A proximal end side outer peripheral surface of a rod (base rod) 100 constituting a fishing rod is fixed to the inner surface of the cylindrical portion 2 by adhesion or the like, and the grip portion 50 is fixed to the outer peripheral surface of a cylindrical protrusion 4a formed to protrude along the axial center X direction on the rear side of the seat body 1A (a rear cylindrical portion 4B having a cylindrical shape in which an inclined surface described later is formed), and is configured to be flush with the surface of the rear cylindrical portion 4B. In this case, the rear cylindrical portion 4B is also a portion gripped and held together with the grip portion 50, and serves as a grip.

Note that the configuration of the fishing rod to which the reel seat 1 is fixed is not limited and may be a telescopic extension type, a jointed type, a single body type and the like, and in FIG. 1, a part of the fishing rod (the rear end side of the base rod) is illustrated, and the entire configuration is omitted. In addition, an example in which, a double-bearing reel (hereinafter, also referred to as a reel) of a low profile type is attached and fixed to the reel seat 1 as a fishing reel 200 is shown.

The seat body 1A comprises a reel leg placement portion 3 on which a reel leg 201 of the fishing reel 200 is placed and a fixed hood 8 disposed on the rear side in the axial direction of the reel leg placement portion 3, and a moving hood 9 is disposed on the front side in the axial direction of the reel leg placement portion 3 on the front side of the seat body 1A. That is, the fishing reel 200 is mounted on and fixed to the reel seat 1 by placing the reel leg 201 on the reel leg placement portion 3 and fastening the front end side thereof by the moving hood 9 moving in the axial direction in a state where the rear end side thereof is fitted in the fixed hood 8.

The seat body 1A comprises an intermediate connecting portion (also referred to as a bridge portion) 5 that connects the front cylindrical portion 4A and the rear cylindrical portion 4B in the axial direction, and these portions are integrally formed. The bridge portion 5 is formed in a substantially semi-cylindrical shape in which an upper side thereof is opened and recesses 5a are formed on both sides, and the reel leg placement portion 3 is integrally formed between the recesses 5a on both sides. In this case, the reel leg placement portion 3 may be formed to be continuous in the axial direction, but in order to reduce the weight, may be divided into a placement surface 3a that supports the back surface on the front end side of the reel leg 201 and a placement surface 3b that supports the rear end side such that the intermediate portion thereof is discontinuous.

A bulging portion 5b bulging in the radial direction is formed along the axial direction below the bridge portion 5 (on the side opposite to the surface of the grip portion 50). The bulging portion 5b is a portion (a portion that is gripped) against which the balls of the index finger and the middle finger abut when the grip portion 50 is gripped, and it is preferable that the surface thereof has a curved shape (for example, as illustrated in FIGS. 3 and 4, a curved shape whose central region bulges downward) along the axial direction so that finger contact is favorable. In addition, in the case of forming such a bulging portion 5b, it is preferable to form the inside as a cavity so as to achieve weight reduction.

To be noted, when the inside of the bulging portion 5b is formed as a cavity, it is preferable to form a reinforcing rib 5c on the inner surface of the bulging portion 5b so as to achieve thickness reduction while maintaining strength. As illustrated in FIG. 3(a), such a reinforcing rib 5c can be appropriately modified by, example, forming the reinforcing rib 5c on the inner surface of the bulging portion 5b along the axial direction, forming the reinforcing rib 5c along a side direction, or a combination of these. In addition, a part of the reinforcing rib may be formed at a height that matches the placement surfaces 3a and 3b to have a function as a reel leg placement portion.

As illustrated in FIG. 3(b), an upper edge portion 5a′ defining the recesses 5a on both sides of the bridge portion 5 of the seat body 1A extends horizontally with an intermediate portion being most recessed and is inclined upward toward the front side and the rear side, the front side thereof is connected to the front cylindrical portion 4A constituting the seat body, and the rear side thereof is connected to the rear cylindrical portion 4B constituting the seat body. On the front side of the front cylindrical portion 4A, the cylindrical portion 2 having a diameter smaller than that of the cylindrical portion 4A is formed to protrude toward the front side. In addition, the placement surface 3b is formed inside the rear cylindrical portion 4B, and the fixed hood 8 defining an opening 8a into which the reel leg 201 is fitted is formed on the rear side of the placement surface 3b.

In addition, the seat body 1A comprises, on the rear side of the fishing reel 200 attached to and fixed to the reel leg placement portion 3 (placement surface 3b), an inclined surface 10 that connects an upper end position P1 of the hood portion 8A defining the opening 8a of the fixed hood 8 to the surface of the grip portion 50 to be gripped on the rear side of the fishing reel 200. The inclined surface 10 is inevitably formed on the seat body 1A by offsetting the reel leg placement portion 3 of the seat body 1A, and is formed on the rear cylindrical portion 4B as described above (as will be described later, the inclined surface 10 is configured to facilitate operation of a clutch lever 205 of the fishing reel 200).

The moving hood 9 that moves in the axial direction is disposed in the cylindrical portion 2 on the front side of the seat body 1A. The moving hood 9 of the present embodiment is constituted by a moving member 9a disposed at a position where a part of the surface of the cylindrical portion 2 is cut out. That is, as illustrated in FIG. 2, the cylindrical portion 2 is constituted by a large-diameter portion 2A on the rear side and a small-diameter portion 2B on the front side, and a cutout portion 2c cut out in an arc shape in a predetermined range along the axial direction is formed in a lower region of the large-diameter portion 2A and the small-diameter portion 2B. Further, the moving member 9a formed in an arc shape along the axial direction is integrally disposed on the large-diameter portion 2A side of the cutout portion 2c, and the moving member 9a is positioned in the cutout portion 2c to constitute the large-diameter portion 2A having a cylindrical shape.

A male screw portion 9b is formed on the surface of the moving member 9a on the front side, and a hood portion 9A that is curved radially inward and defines an opening 9c for receiving the reel leg is formed on the rear side so as to receive the reel leg 201. The hood portion 9A of the moving member 9a is disposed so as to enter the opening 5A formed in a lower portion of the front end surface of the bridge portion 5 (end surface of the front cylindrical portion 4A), and the opening 5A is connected to the reel leg placement portion 3 (placement surface 3a) as illustrated in FIG. 4(a). That is, when the moving member 9a moves rearward, the hood portion 9A thereof is fitted into a front end portion of the reel leg 201 placed on the placement surface 3a in the opening 5A.

A female screw portion 12a formed on the inner surface of a nut member 12 externally fitted to the large-diameter portion 2A is screwed onto the male screw portion 9b of the moving member 9a. That is, when the nut member 12 is rotationally operated in one direction, the moving member 9a moves to the rear side in the axial direction to tighten the front end side of the reel leg 201 (attached and fixed state of the reel), and when the nut member 12 is rotationally operated in the other direction, the moving member 9a moves to the front side in the axial direction to release the front end side of the reel leg 201 (detached state of the reel). To be noted, a circumferential groove 2d is formed along the circumferential direction on the front end side of the large-diameter portion 2A, and the nut member 12 is restricted so as not to come off to the front side by attaching a ring-shaped member 12b to this portion. In addition, when the nut member 12 is externally fitted to the large-diameter portion 2A, the surface thereof is configured to be flush with the surface of the front cylindrical portion 4A as illustrated in FIG. 1 without generating a step so as to be easily gripped.

A cylindrical member 2e is bonded to the small-diameter portion 2B, a grip portion (front grip) 51 is fixed on the cylindrical member 2e so as to be flush with the surface of the nut member 12 to be rotated. To be noted, on the inner surface side of the cylindrical member 2e, a protruding portion 2e′ protruding inward along the axial direction and fitted to the cutout portion 2c formed in a lower region of the small-diameter portion 2B is formed, and the cylindrical member 2e is bonded to the small-diameter portion 2B in a state of being prevented from rotating. In addition, a configuration in which the grip portion 51 is not provided may be employed.

As described above, the inclined surface 10 formed on the rear cylindrical portion 4B gradually rises rearward from the upper end position P1 of the hood portion 8A defining the opening 8a of the fixed hood 8, and connects up to the surface of the grip portion 50. In the present disclosure, the offset amount of the reel leg placement portion 3 with respect to the axial center X is not limited, but when the offset amount is large, the position of the clutch lever disposed between the side plates is also lowered when a double-bearing reel having a low profile is attached, and a sufficient gap is not secured with respect to the inclined surface 10, and the clutch OFF/clutch ON operation becomes difficult to perform.

For this reason, as illustrated in FIG. 4, the inclined surface 10 is formed such that an inclination angle α of rising from the upper end position P1 of the hood portion 8A toward a grip upper surface (inclination angle of upward inclination with respect to the axial center X) does not exceed 45° as viewed from the side, such that even when the small reel 200 is attached, the clutch lever 205 disposed between the side plates can be operated without any problem.

That is, by setting the inclination angle of the inclined surface rising from the upper end position P1 of the hood portion 8A to 45° or less, a sufficient gap is secured between the clutch lever 205 and the inclined surface 10, particularly, a gap to the extent that the finger can be easily pressed against the lower surface of the clutch lever is secured when the clutch is turned from OFF to ON. Actually, when the inclination angle α of the inclined surface 10 exceeds 45° , the inclined surface becomes steep, and the clutch operation becomes difficult particularly when the offset amount is increased. In addition, the inclination angle 45° is an intermediate angle between the horizontal state and the vertical state, and it is easy to grasp the sense at the time of gripping, and when the inclination angle rises to this angle or more, this angle is more likely to be sensed as steep and a sense of discomfort tends to occur. However, by setting the inclination angle to 45° or less, such a sense of discomfort can be reduced.

Further, the inclined surface 10 is formed such that an inclination angle (inclination angle of downward inclination with respect to the axial center X) β of descending from the upper surface (surface) of the grip portion 50 does not exceed 35° . Here, the inclination angle β is defined by a descending angle at a position P2 where the grip portion 50 starts to descend forward on the upper surface, and is configured such that sudden descent beyond 35° does not occur.

As described above, by setting the inclination angle α of the inclined surface 10 of the seat body rising from the upper end position P1 of the hood portion 8A toward the grip upper surface to 45° or less, and setting the inclination angle β of the inclined surface 10 descending from the upper surface (a descending starting position P2) of the grip portion 50 to 35° or less, a gap is secured on the lower end side of the inclined surface, and the inclination on the upper end side becomes gentler, and thus, a gap into which a finger enters can be sufficiently secured between the inclined surface 10 and the reel (clutch lever 205). That is, if the inclination angle α of rising toward the grip upper surface is constant (constant at 45° or less), the descending angle is too large and thus gives a sense of discomfort when the thumb is inserted from the upper surface of the grip portion 50 to the lower surface of the clutch lever 205, but by setting the inclination angle β of descending to 35° or less as described above, the thumb located on the upper surface of the grip portion 50 or the thumb located on the upper portion of the inclined surface can be moved along the inclined surface as it is to be easily inserted smoothly into the lower surface of the clutch lever 205. As a result, a series of operations such as performing OFF operation of the clutch lever 205 while gripping the reel seat 1 portion of the fishing rod, performing ON operation of pushing up the clutch lever 205 with the thumb after the rig is landed on the water, and then performing winding operation can be smoothly repeated, and the thumb does not become hurt.

In the above-described configuration, the inclined surface 10 may be formed of a linear composite surface having a different rising angle and a different descending angle when viewed from the side, but as illustrated in FIGS. 1 and 4, the inclined surface is preferably formed of a curved surface that rises and ascends from the upper end position P1 of the hood portion and whose inclination is gentler at a position closer to the grip upper surface side.

By configuring the inclined surface 10 as a curved surface in this manner, the thumb does not become hurt even when used for a long time, and a series of operations from the casting operation to the winding operation can be smoothly performed. When the rising inclination angle α described above is 45° or less and the descending inclination angle β is 35° or less, appropriate modification such as the bulging the intermediate portion thereof can be performed.

In addition, the inclined surface 10 may have a configuration in which both the rising inclination angle α and the descending inclination angle β are equal to each other or may be formed in a relationship of α<β as long as the rising inclination angle α and the descending inclination angle β satisfy the above-described condition. By forming the inclination angle α to 35° or less, the gap between the reel and the inclined surface becomes wider, and the clutch operation can be performed more easily.

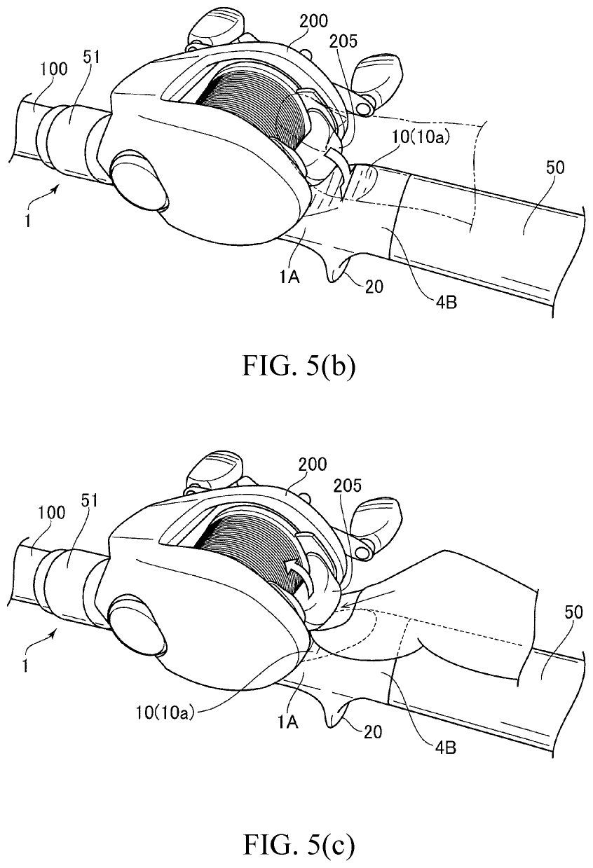

In addition, the cross-sectional shape of the surface of the inclined surface 10 in the direction orthogonal to the axial direction may be flat or may be constituted by a curved surface. As illustrated in FIG. 4(b), the cross-sectional shape of the surface of the inclined surface 10 of the present embodiment is configured to have a recessed portion 10a in which the central region is recessed. The recessed portion 10a is constituted by a surface in which the entire surface of the inclined surface 10 is curved (a surface curved with substantially the same curvature in section view), and according to such a recessed portion 10a, as illustrated in FIGS. 5(a) to 5(c), the ball of the thumb easily conforms to the inclined surface (the surface of the recessed portion 10a), and the clutch operation can be stably and easily performed. In particular, when the clutch is switched from ON to OFF, the thumb can be smoothly guided to the lower surface of the clutch lever by pushing down the clutch lever, shifting the thumb backward as it is, and shifting the finger forward as it is, and thus the ON operation can be easily performed from the OFF state.

In addition, in the seat body 1A of the present embodiment, a trigger 20 is formed on the opposite side of the grip upper surface so as to protrude from a position (lower position of P1) corresponding to the upper end position P1 of the hood portion 8A while gradually curving downward. Since the protruding position of the trigger 20 is formed within the range in the axial direction of the inclined surface 10, when the finger is placed on the trigger 20, the operation of the thumb can be stably performed without opening the palm, and the above-described clutch operation can be stably performed.

The seat body 1A, the moving hood 9, and the nut member 12 are preferably integrally formed of a hard resin material or a fiber-reinforced resin material so as to achieve weight reduction. For example, by integrally forming with a hard synthetic resin material such as nylon and ABS, or a plastic composite material (FRP) with reinforcing fibers mixed such as glass fibers and carbon fibers, it is possible to effectively reduce weight while maintaining strength. Alternatively, it may be formed of a lightweight metal material such as aluminum.

In addition, the grip portions 50 and 51 can be made of a soft material such as, for example, natural cork, urethane, EVA, thermoplastic elastomer, rubber, or the like that can improve feeling when the grip portions 50 and 51 are gripped, grip performance, and appearance, and can reduce weight, or can be formed by applying these materials.

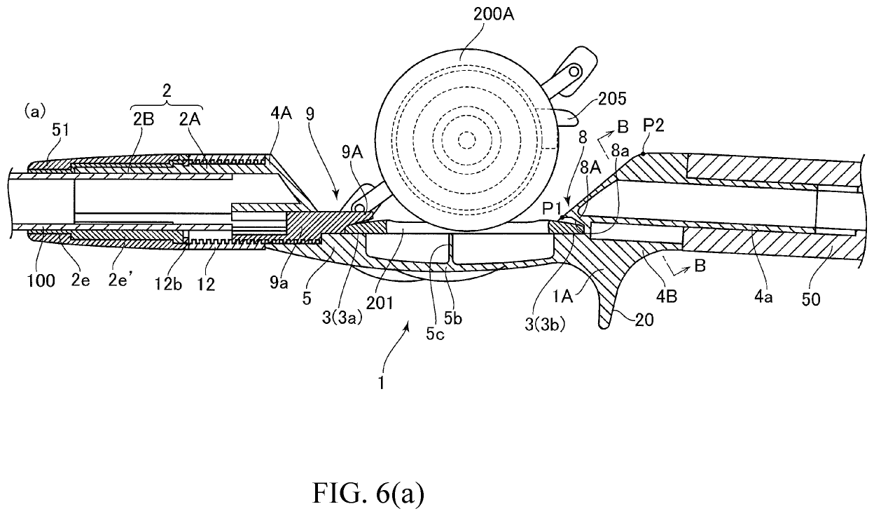

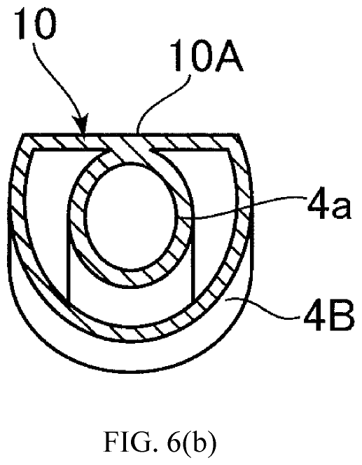

FIG. 6 is a diagram illustrating a modification example of the reel seat, in which FIG. 6(a) is an axial section view illustrating a state in which a round fishing reel is attached to and fixed to the reel seat, and FIG. 6(b) is a section view of an inclined surface viewed from a direction orthogonal to the axial direction.

In this modification, a fishing reel 200A having round side plates is mounted on a reel seat 1, and a cross-sectional shape of the surface of an inclined surface 10A in a direction orthogonal to the axial direction is formed to be flat as illustrated in FIG. 6(b).

When the round fishing reel 200A is mounted, the position of the clutch lever 205 is shifted upward as compared with the low profile fishing reel illustrated in FIG. 1, so that the gap on the rear side of the clutch lever becomes wider, and a series of operations can be performed more easily. In addition, even if the surface of the inclined surface 10A is made flat, the thumb does not become hurt, and a series of operations can be smoothly performed.

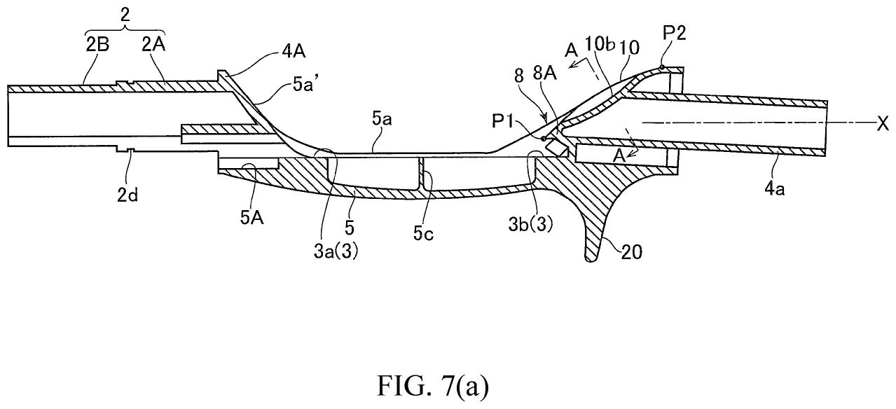

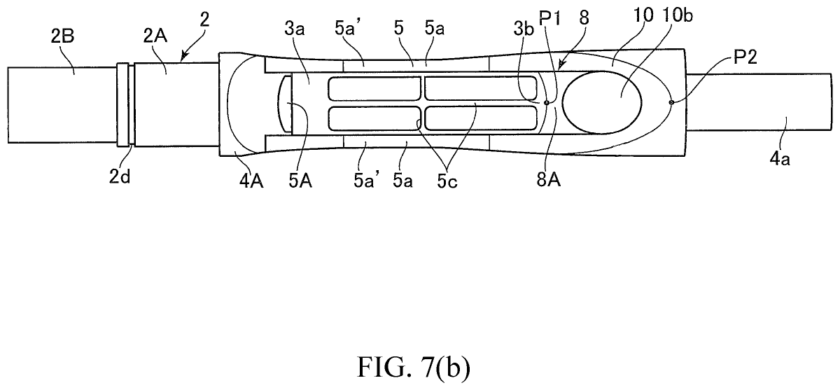

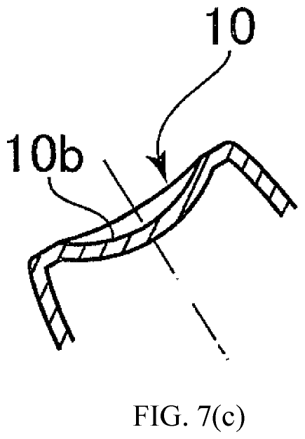

FIG. 7 is a diagram illustrating a second modification example of the reel seat, in which FIG. 7(a) is an axial section view, FIG. 7(b) is a plan view, and FIG. 7(c) is an A direction section view of FIG. 7(a).

A recessed portion 10b of the inclined surface 10 of this modification example is constituted by a curved surface in which the central region of the inclined surface is recessed in a substantially elliptical shape in plan view and the central region is the most recessed. According to the recessed portion 10b recessed in this manner, it is possible to further increase the gap into which the finger enters between the clutch lever 205 of the reel and the inclined surface 10, and thus, it is possible to more easily perform the switching operation of the clutch lever, particularly, the return operation from OFF to ON.

While the embodiment of the present disclosure has been described above, the present disclosure is not limited to the above-described embodiment and can be variously modified.

In the above-described configuration, the inclination angle of the inclined surface 10 formed on the seat body 1A is arbitrary, and the surface shape thereof can be appropriately modified to a curved shape, a flat surface, a composite surface of these, or the like. In addition, the surface shape of the recessed portion formed on the inclined surface can also be appropriately modified to a partially recessed shape, a recessed shape in a composite surface in which flat and curved depressions are combined, a partially bulged shape, or the like. Further, the configuration of the moving hood (moving method in the axial direction, position fixing structure, and the like) can be variously modified, and the means for moving the moving hood in the axial direction is not limited to the method using the nut member 12 described above.

In addition, the shape of the seat body 1A is not limited to the shape illustrated in the drawings, and can be variously modified. For example, appropriate modification such as partially forming a bulging portion or a recessed portion (curved portion) from a curved surface, an inclined surface, or the like, or further forming a lightening portion, a cutout portion, an opening, or the like, can be made for better fitting with the pad of the finger and the palm. Such lightening, cutout, unevenness, and the like are preferably formed in a portion that does not affect grip performance, and a thickness of the seat body 1A is not limited.

### REFERENCE SIGNS LIST

1 Reel seat

1A Seat body

3, 3a, 3b Reel leg placement portion

5 Intermediate connecting portion (bridge portion)

8 Fixed hood

9 Moving hood

10 Inclined surface

10a, 10b Recessed portion

50, 51 Grip portion

200, 200A Fishing reel

205 Clutch lever

1. A reel seat comprising a seat body including a reel leg placement portion on which a reel leg of a fishing reel is placed, a fixed hood provided on a rear side of the reel leg placement portion in an axial direction, and a moving hood provided on a front side of the reel leg placement portion in the axial direction, a position of the reel leg placement portion being offset in a descending direction with respect to a position of an axial center of a rod when the seat body is fixed to the rod, the reel seat comprising:
an inclined surface provided on a rear side of the fishing reel attached to and fixed to the reel leg placement portion and connecting an upper end position of a hood portion defining an opening of the fixed hood to a grip upper surface gripped on the rear side of the fishing reel,
wherein the inclined surface is formed such that an inclination angle of rising toward the grip upper surface from the upper end position of the hood portion does not exceed 45° and an inclination angle of descending from the grip upper surface does not exceed 35° in side view.

2. The reel seat according to claim 1, wherein the inclined surface is formed as a curved surface that rises and ascends from the upper end position of the hood portion and whose inclination is gentler at a position closer to the grip upper surface side.

3. The reel seat according to claim 1, wherein a cross-sectional shape of a surface of the inclined surface in a direction orthogonal to the axial direction is formed to be flat.

4. The reel seat according to claim 1,
wherein a cross-sectional shape of a surface of the inclined surface in a direction orthogonal to the axial direction has a recessed portion whose central region is depressed.

5. A reel seat comprising a seat body including a reel leg placement portion on which a reel leg of a fishing reel is placed, a fixed hood provided on a rear side of the reel leg placement portion in an axial direction, and a moving hood provided on a front side of the reel leg placement portion in the axial direction, a position of the reel leg placement portion being offset in a descending direction with respect to a position of an axial center of a rod when the seat body is fixed to the rod, the reel seat comprising:
an inclined surface provided on a rear side of the fishing reel attached to and fixed to the reel leg placement portion and connecting an upper end position of a hood portion defining an opening of the fixed hood to a grip upper surface gripped on the rear side of the fishing reel,
wherein a cross-sectional shape of a surface of the inclined surface in a direction orthogonal to the axial direction has a recessed portion whose central region is depressed.

6. The reel seat according to claim 1,
wherein a trigger is formed on a side of the seat body opposite to the grip upper surface so as to protrude from a position corresponding to the upper end position of the hood portion while being curved.

7. The reel seat according to claim 1,
wherein a bulging portion that bulges in a radial direction along the axial direction on a side opposite to the grip upper surface and whose inside is a cavity is formed in the seat body.

8. The reel seat according to claim 1,
wherein the seat body is integrally formed of a hard resin material or a fiber-reinforced resin material.

9. A fishing rod to which the reel seat according to claim 1 is fixed.
